(19) United States
(12) Patent Application Publication
(10) Pub. No.: US 2026/0313198 A1
(43) Pub. Date: Oct. 8, 2026

(54) SYSTEM AND METHOD FOR DETECTION OF AUDIENCE PRESENCE AND PRESENCE CONTROL OF TELEVISION WITH RADAR

(71) Applicant: Telly, Inc., Sherman Oaks, CA (US)

(72) Inventors: Eric Loes, Seattle, WA (US); Rex Ching, Santa Clara, CA (US); Ilya Pozin, Los Angeles, CA (US); Jonathan Lin, Aliso Viejo, CA (US); Sascha Prueter, Daellikon (ZH); John Hwang, Costa Mesa, CA (US); Zachary Ferres, Phoenix, AZ (US); Joseph Yao-Hua Chu, San Jose, CA (US)

(21) Appl. No.: 19/483,205

(22) PCT Filed: May 9, 2024
(86) PCT No.: PCT/US2024/028656

§ 371 Date: Nov. 10, 2025

Related U.S. Application Data
(60) Provisional application No. 63/465,186, filed on May 9, 2023.
(60) Provisional application No. 63/465,190, filed on May 9, 2023.

(51) Int. Cl. H04N 21/443; H04N 21/442; H04N 21/485

(52) U.S. Cl. CPC H04N 21/4436; H04N 21/44218; H04N 21/4854

(57) ABSTRACT

A television includes a first display configured to display streaming video content at a first brightness level, and a second display configured to display interactive content supplemental to the video content at a second brightness level. The television also includes a sensor configured to detect objects in a viewing area in proximity to the television. One or more processors of the television receive detection inputs from the sensor; perform a first presence evaluation based on the detection inputs, wherein the first presence evaluation determines that there is a presence or an absence of persons in the viewing area for an amount of time that satisfies a first threshold; and based on the first presence evaluation, perform a first adjustment to one or more power settings of the first display and/ or the second display causing the first brightness level and the second brightness level to be different.

### RELATED APPLICATIONS

The present application claims priority to U.S. Provisional Application Ser. No. 63/465,190, filed May 9, 2023, entitled “System and Method for Person Detection and Presence Control of Television with Integrated Camera or Radar,” and U.S. Provisional Patent Application 63/465,186, filed May 9, 2023, entitled “System and Method for Person Detection and Presence Control of Television with Integrated Camera or Radar,” which are each hereby incorporated by reference in their respective entireties.

### TECHNICAL FIELD

The present application relates to television displays and, more particularly, to a television that includes one or more screens and an integrated millimeter wave detector (or other sensor technology) for detecting the number of persons/viewers (the total size of an audience (not the identity any individual) in front of a television) and providing functionality related to control, energy savings (device power consumption), content, and advertising.

### BACKGROUND

The proliferation of streaming video applications and the availability of video content online have led to increased demands being placed on televisions to display traditional television content and make additional streaming or internet-based content available to television users.

Limitations of existing televisions, however, lead to clumsy control or presentation of interactive content over a program on the screen that is not relevant because nobody is present to watch it. In addition, screen overlays may interfere with viewing a currently displayed television program.

Existing televisions generally have incorporated a single display screen to present television content to users. Some televisions have allowed picture in picture for watching programs while navigating menus and split screen functionality that allows users to watch more than one television program at a time. However, this functionality has generally been limited to displaying programs and menus on the same screen at a reduced size. Televisions have also been arranged in arrays to allow single television sets to be physically placed in an array to each display part of a larger picture that is captured in the entire array.

There is a need for a television that allows the presentation of a television program or streaming content, when viewers are present and in such a manner that the additional content, features and functionality do not interfere with the television program. There is a further need for a television that has a degree of automatic control based on whether viewers are present. There is a further need for a television that maximizes the ability to provide content and interactive content in a manner based on whether movement of persons in a room is detected.

### SUMMARY

According to an embodiment of the present disclosure, a sensor on the front of a television is used to determine whether persons (vs. an object or animal) are present and/or the number of persons present. The sensor may be a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor. The detection of presence of persons may be used to automatically turn on and off the television. Once the number of persons is determined, the television may make automatic changes to the configuration, programming, content, and/or advertising based on the number of persons detected. The processing to determine the presence of persons may be performed locally on the television based on the radar to preserve such information locally for immediate use. The systems and methods described herein are preferably adapted to two screen televisions where the content for one or both screens is selected based on the detection of persons, and the content for the second screen may be further selected by the content on the first screen. Throughout this specification, the terms “screen” and “display” are used interchangeably.

According to additional embodiments of the disclosure, the sensor may determine the distance of viewers from the television and use the distance to determine or adjust the configuration, control, content, and/or advertising on one or both screens. According to still another embodiment, the radar may detect whether persons in the room are moving and may determine or adjust the configuration, control, content, and/or advertising on one or both screens based on such perceived movement. The detection of persons may also be used to count and measure the reach and frequency of content and advertising viewing information and monetization for a variety of post content and ad delivery reporting and analytics purposes such as measuring the size of an audience watching a show or viewing or interacting with an advertisement.

A television that provides detection of whether a person is present, comprises: a television screen; a memory for storing program instructions corresponding to a person detection application; a remote control; a sensor capable of detecting objects in front of the television; at least one source of content comprising a source coupled to an HDMI port and a source coupled to the Internet; and a processor, coupled with the screen, memory, remote control, and at least one source of content, the processor capable of executing program instructions to: (i) execute the person detection application to detect a lack of presence (and number) of persons near the television and turn off the television screen; and (ii) execute the person detection application to detect a presence (and number) of persons near the television and turn on the television screen.

The sensor may be radar based. The sensor may further be used to determine the number of persons present. The television may comprise two screens and present content and advertising on the second screen based on the number of persons present or the lack of persons present.

According to another embodiment, the disclosed embodiments may find application in a television that provides two integrated television screens. In this embodiment, the lower television screen may be approximately ¼ to ⅓ the height of the upper television screen, which is preferably 16:9. This allows a television viewer to watch a standard 16:9 television screen while simultaneously watching a smaller, lower screen for multitasking. Additionally, the lower screen can be on while leaving the upper screen off for media consumption including text, graphics, advertising, video, and audio. This arrangement facilitates providing a full range of interactive content, control, and features to users via the provision of applications that may control either screen or both screens simultaneously. Such applications enable the linking of content, control, and features between the two screens and ancillary devices such as a sound bar, which may also be integrated into the television.

### BRIEF DESCRIPTION OF THE DRAWINGS

The above described features and advantages of the present disclosure will be more fully appreciated with reference to the following figures.

FIG. 1 depicts a television that integrates two distinct screens and concurrent functionality according to an embodiment of the present disclosure.

FIG. 2 depicts a functional block diagram of a television that integrates two distinct screens and concurrent functionality for an electronic program guide on one of the screens according to an embodiment of the present disclosure.

FIG. 3 depicts a method of detecting the presence of (and number) of persons in front of a television and controlling the television based on presence.

FIG. 4 depicts a method of detecting the number of persons in front of a television and selecting programming for a first and a second screen based on the number of persons, according to an embodiment of the present disclosure.

FIG. 5 depicts a method of detecting a distance and movement of persons near the television and selecting content and/or configurations based on the distance or movement, according to an embodiment of the present disclosure.

FIGS. 6A-6B illustrate causing a display of a two-display system to activate in response to detecting a presence of a person within a region of the display system, in accordance with some embodiments of the present disclosure.

FIGS. 7A-7B illustrate causing a display of a display system to activate in response to detecting a presence of a person within a region of the display system, in accordance with some embodiments of the present disclosure.

FIGS. 8A-8B illustrate causing displays of a display system to un-dim in response to detecting a presence of a person within a region of the display system, in accordance with some embodiments of the present disclosure.

FIGS. 9A-9B illustrate how a display system responds to detecting that a person is no longer within a region of the display system, in accordance with some embodiments of the present disclosure.

FIGS. 10A-10B illustrate how a display system responds to detecting that a person is no longer within a region of the display system, in accordance with some embodiments of the present disclosure.

FIGS. 11A-11B illustrate how a display system responds to detecting that a person is no longer within a region of the display system, in accordance with some embodiments of the present disclosure.

FIG. 12 includes a method flow chart that describes additional embodiments and variations of the embodiments described in reference to FIGS. 1-11B, in accordance with some embodiments.

### DETAILED DESCRIPTION

According to an embodiment of the present disclosure, a presence sensor on the front of a television is used to determine the presence of viewers and/or number of viewers. The sensor may be a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor. The presence of viewers may be used to automatically turn on and off the television. Once the number of viewers is determined, the television may make automatic changes to the configuration, programming, content and/or advertising for the number of viewers. The processing to determine the number of persons may be performed locally on the television based on the radar to preserve such information locally for immediate use.

The systems and methods described herein are preferably adapted to two screen televisions where the content for one or both screens is selected based on the presence of persons detection information, and the content for the second may be further selected by the content on the first screen. However, the system and methods may be applied to televisions with only one screen, or more than two screens.

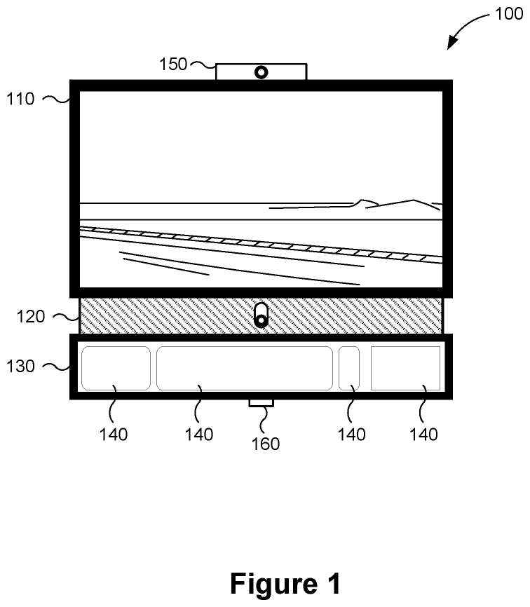

FIG. 1 depicts an illustrative television 100 that integrates two distinct screens and concurrent functionality according to an embodiment of the present disclosure. Referring to FIG. 1, the television includes an overall housing and an upper screen 110 and a lower screen 130. The upper and lower screen may be separated by an optional sound bar 120. Alternatively, the screens may be separated by a physical divider or placed adjacent to one another. The lower screen may be portioned into areas where the screen output is determined by widget programs 140, that present information, interactive or otherwise to users. In some embodiments, the television further includes a presence sensor 150, and a microphone 160. In some embodiments, the presence sensor is configured to just detect the presence of people within a proximity of the television (e.g., through the use of a passive infrared (PIR) sensor). In some embodiments, the presence sensor is configured to also count the number of people (e.g., through one or more of a time-of-flight (ToF) sensor, an IR sensor, a thermal sensor, a radio frequency sensor (e.g., millimeter wave sensor, an ultrawideband (UWB sensor), an ultrasonic sensor, a WiFi sensor, BLE sensor), a time-of-flight sensor.

According to an embodiment of the disclosure, the lower television screen 130 is approximately ¼ to ⅓ the height of the upper television screen 110, which preferably has an aspect ratio of 16:9. This allows a television viewer to watch a standard 16:9 television screen while simultaneously watching a smaller, lower screen for multitasking. Additionally, the lower screen can be on while leaving the upper screen off for media consumption including text, graphics, advertising, video, and audio. This arrangement facilitates providing a full range of interactive content, control, and features to users via the provision of applications that may control either screen or both screens simultaneously. Such applications enable the linking of content, control, and features between the two screens and ancillary devices such a sound bar, which may also be integrated into the television.

According to some embodiments, the integrated television screens may comprise separate television panels integrated into a single television, with or without a soundbar. In other embodiments, for example, a single 4:3 panel may be configured with a physical screen divider and hardware and software provisioning to divide the television into two separate integrated screens. According to one embodiment, HDMI ports may deliver video to the upper screen only. In other embodiments, the HDMI ports may deliver video to the upper and lower sections.

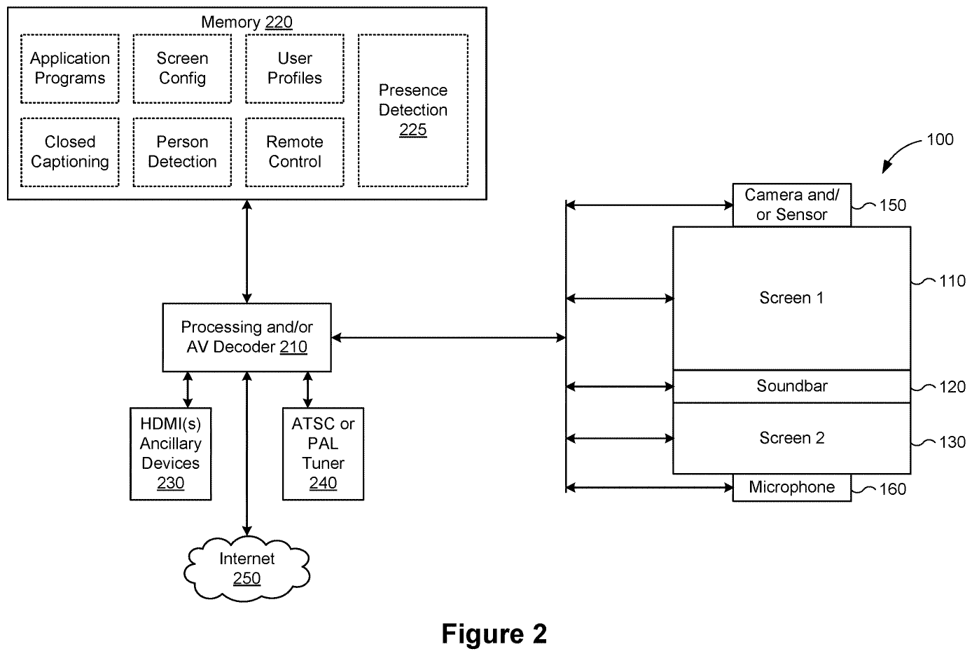

FIG. 2 depicts a functional block diagram of a television that integrates two distinct screens and concurrent functionality according to an embodiment of the present disclosure.

Referring to FIG. 2, a television 100 according to an embodiment of the present disclosure incorporates a processor 210 coupled with a memory 220, HDMI ports 230, an ATSC or PAL tuner 240, a millimeter wave sensor 150, a microphone 160, speakers or an optional soundbar 120, the internet 250, and two distinct screens 110 and 130 as described above. The memory 220 may store programs, that include program instructions that are executed by the processor to enable the various functionalities of the television. The memory 220 may include, for example, application programs, an electronic program guide application program, a screen configuration program, a presence detection program 225and a remote control program, among others.

The HDMI ports enable A/V devices 230 to be connected to the television, including DVD players, DVRs, sound bars, streaming boxes, A/V Receivers, gaming consoles and other equipment. ATSC or PAL tuners 240 may be incorporated into the television to allow the television to receive over the air or certain cable broadcasts and present them on the main screen, or on the secondary screen.

A microphone 160 may be included in the television to allow the user to provide spoken commands to the television, to allow for video conferencing, and to allow other audio visual applications. A presence sensor 150 may also be provided to facilitate functionality such as recognizing gestures and motion recognition, among other features. The screens are distinct and render images corresponding to content from the HDMI ports 230, from the tuners 240, from the internet 250, streaming or other interconnected devices. In addition, the content of the screens may be determined by application programs or any of the other programs stored in the memory 220 and executed by the processor 210. The speakers and/or optional soundbar 120 are used to provide audio output corresponding to content displayed on the screens or enabled through the application programs or other programs provided on the television. The television may also incorporate an RF receiver or IR port for receiving signals from a remote control used to control the television.

The processor 210 may be a single micro-processor, multiple processors, or a processor and a co-processor. In one embodiment, a primary micro-processor may be used to render and operate the user interface while a second processer maybe used to decode video, for example H.264 format outputting a signal via HDMI. The processor(s) may support all functionality needed to operate the display screens of the television, and synchronize images with audio output, including rendering, video decoding, audio decoding, audio visual synchronization control, motion estimation and motion compensation, picture quality, time stamp normalization, frame rate control, and over the air updates. In addition, the processor(s) 210 execute program instructions from memory to enable applications to be presented on one or both screens of the television, and to permit use of the speakers, microphone, internet connection, remote control, and two-way communication with ancillary devices connected to the television, such as content streaming hardware. According to an embodiment of the present disclosure, the processor 210 may be an application processor designed specifically for smart display applications such as the A311D2 processor, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interphases such as for Ethernet, USB, SDIO 3.0, eMMC 5.1, SDIO/SD card controller, UART, 12C, high-speed SPI PWMs and an IR blaster. The processor may be distributed or a system on a chip and may interface with additional memory and components of the television.

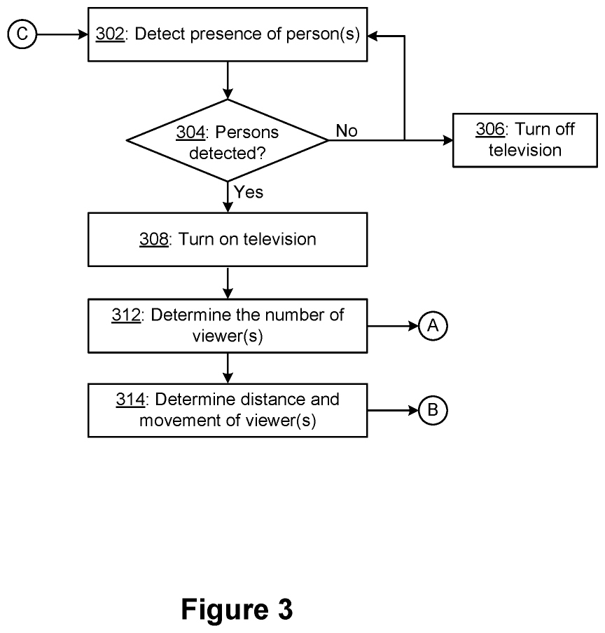

FIG. 3 depicts a method of detecting the presence (and number) of persons in front of a television and controlling the television based on presence. In some embodiments, the method of FIG. 3 repeatedly runs intermittently (e.g., every 5, 10, 20 minutes, etc.) to continuously provide presence detection updates after the initial detection, which in some embodiments can be used for analytics described above. Referring to FIG. 3, the presence detection program 225, when executed by the processor 210, determines the presence of persons present in front of the television as described above, using the presence sensor 150. If persons are not detected, then the television may be turned off after a predetermined period of time, or put in standby. In two or more screen embodiments, one or more screens may be turned off.

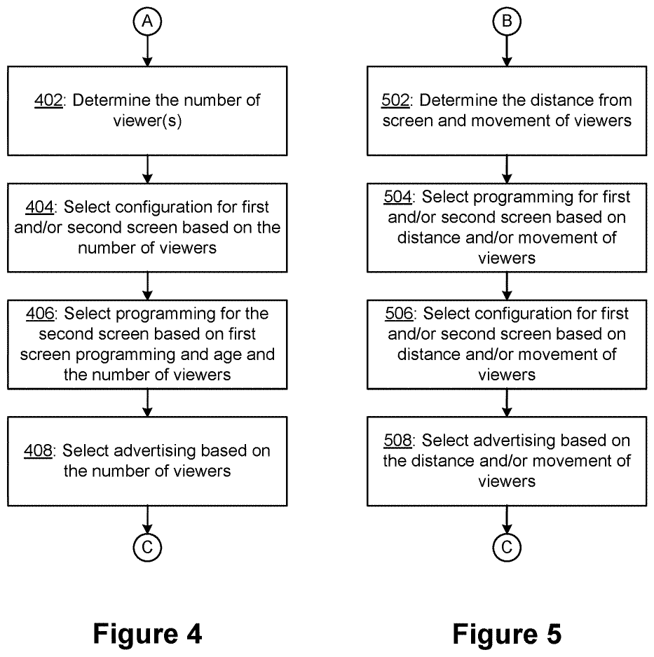

If persons are detected and the television is currently off, then the presence detection application 225, when run by the processor 210, may turn the television on. In addition, the processor executing the presence detection program 225 may determine the number of viewers present which may be an input to the processes shown in FIG. 4.

FIG. 4 depicts a method of detecting the number of persons in front of a television and selecting programming for a first and a second screen based on the number of persons, according to an embodiment of the present disclosure. Referring to FIG. 4, the number of viewers is determined using the millimeter wave detection algorithms described above. Then, configurations for the first and second screen (if present) are selected based on the number of viewers. Content choices may be selected for the first or second screen based on the number of viewers. Additionally, widgets and configurations may be selected based on the number of the viewers present. Finally, advertising may also be selected based on the number of viewers present.

FIG. 5 depicts a method of detecting a distance and movement of persons near the television and selecting content and/or configurations based on the distance or perceived movement, according to an embodiment of the present disclosure. Referring to FIG. 5, the distance of persons is determined using millimeter wave detection algorithms described above along with perceived movement of persons. Such activities include: entering room, exiting room, or other perceived movement such that user is engaged. Then, configurations for the first and second screen (if present) are selected based on the distance of persons and movement. Content choices may be selected for the first or second screen based on the distance of persons and perceived movement (or not). Additionally, widgets and configurations may be selected based on the distance and movement. Finally, advertising may also be selected based on the distance and movement.

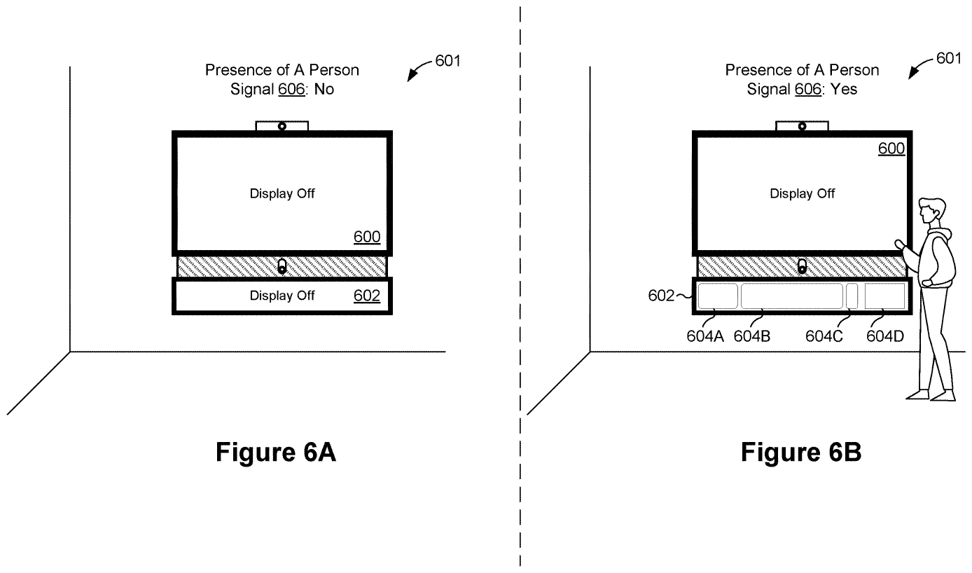

FIGS. 6A-6B illustrate causing a display of a two-display system 601 to activate in response to detecting the presence of a person within a region of the display system 601, in accordance with some embodiments. As shown in FIG. 6A, a first display 600 (e.g., a primary display that is configured to display primary viewing content to a person) and a second display 602 (e.g., a secondary display that is configured to display supplemental, related information, and/or topical information to enhance the viewing experience for the person) are in an off-state in response to no presence of persons being detected.

FIG. 6B shows that in response to the display system 601 detecting, via data from one or more sensors, that a presence of a person signal 606 has come into a predefined distance of the display system 601, a second display 602 is turned on. In some embodiments, the second display can include multiple regions 604A, 604B, 604C, and 604D in which different information can be displayed, including but not limited to: stock information, advertisements, information related to the first display 600, weather information, news, etc.

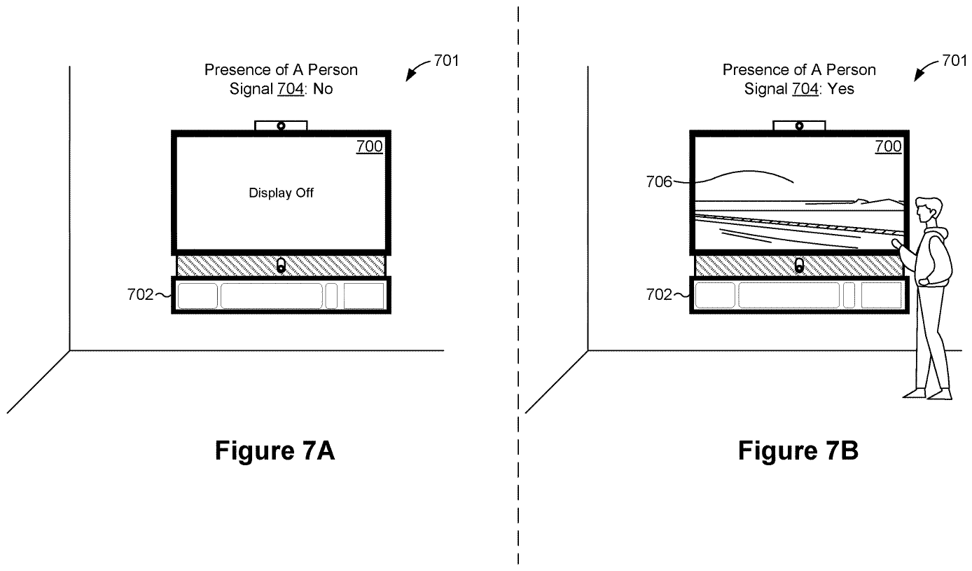

FIGS. 7A-7B illustrate causing a display of a display system 701 to activate in response to detecting a presence of a person within a region of the display system 701, in accordance with some embodiments. FIG. 7A shows that even though no human presence is detected, a second display 702 is in an on state and the first display 700 is in an off state.

FIG. 7B shows how that display system 701 activates in response to detecting a presence of a person signal 704 within a region of the display system 701. As shown, in response to a presence of a person signal 704 coming into proximity of the display system 701, the first display 700 is activated and begins displaying content 706.

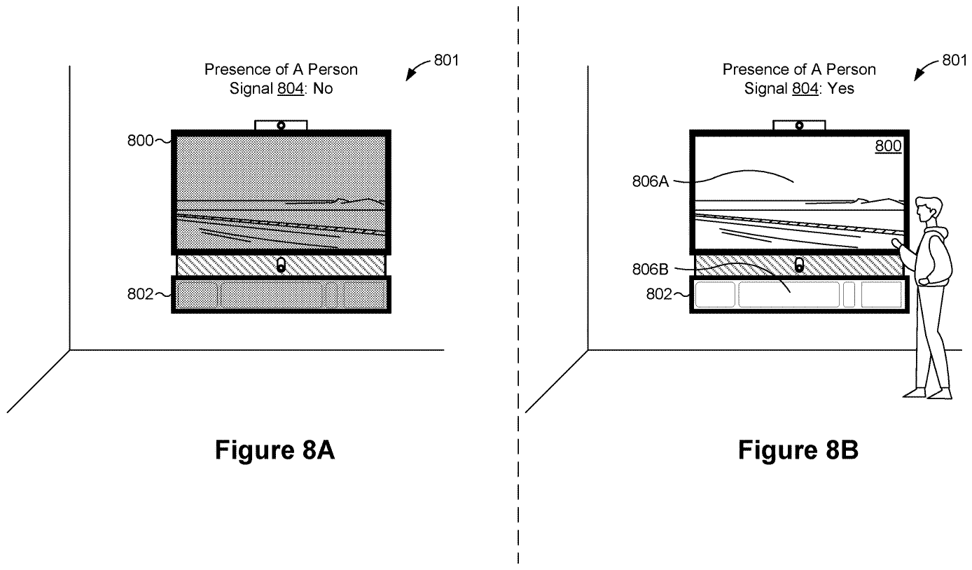

FIGS. 8A-8B illustrate causing displays of a display system 801 to un-dim in response to detecting a presence of a person within a region of the display system 801, in accordance with some embodiments. FIG. 8A shows that when no presence of a person is detected, the first display 800 and the second display 802 operate in a dimmed state (e.g., a low-power state). In some embodiments, the dimmed state can include low-power interface instead of what is displayed when in the activated-on state.

FIG. 8B shows that in response to detecting a presence of a person signal 804 within a region of the display system 801. As shown, in response to a presence of a person signal 804 coming into proximity of the display system 801, the first display 800 and the second display 802 both enter an un-dimmed state allowing a person to better view content 806A and content 806B being displayed on both first display 800 and second display 802, respectively.

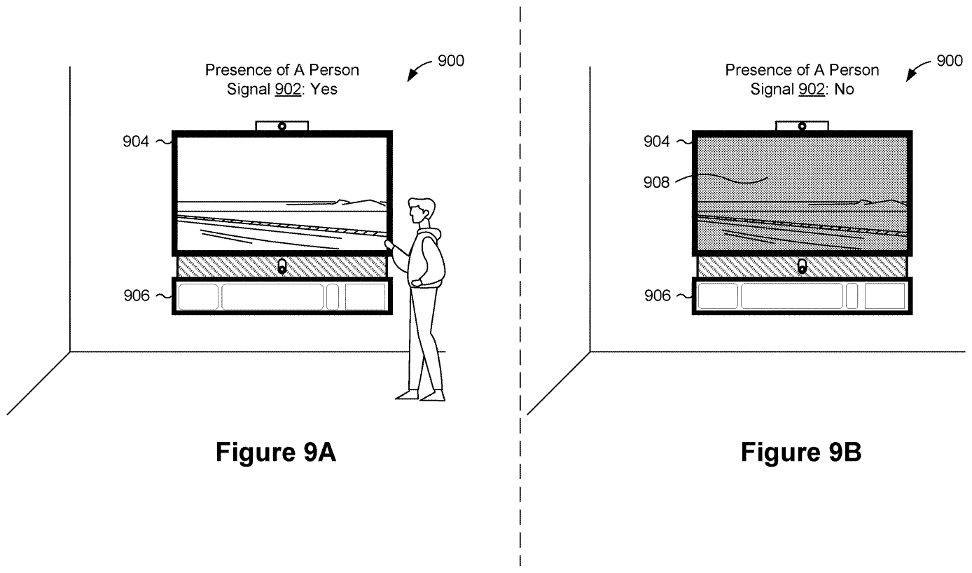

FIGS. 9A-9B illustrate how a display system 900 responds to detecting that a presence of a person signal 902 is no longer within a region of the display system 900, in accordance with some embodiments. As shown in FIG. 9A, a presence of a person signal 902 is within a predefined region (e.g., 10, 20, 30 feet of the display system) of the display system 900. As a result the display system 900 keeps a first display 904 and a second display 906 an activated-on state as the presence of a person signal 902 is within proximity of the display system 900.

FIG. 9B illustrates that in response to a presence of a person signal 902 no longer being in proximity (e.g., outside of a predefined distance and for a predefined period of time (e.g. 5, 10, 20 minutes)) to the display system 900, the first display 904 of the display system 900 enters a dimmed state 908 and maintains an activated-on stated (e.g., un-dimmed state) for the second display 906.

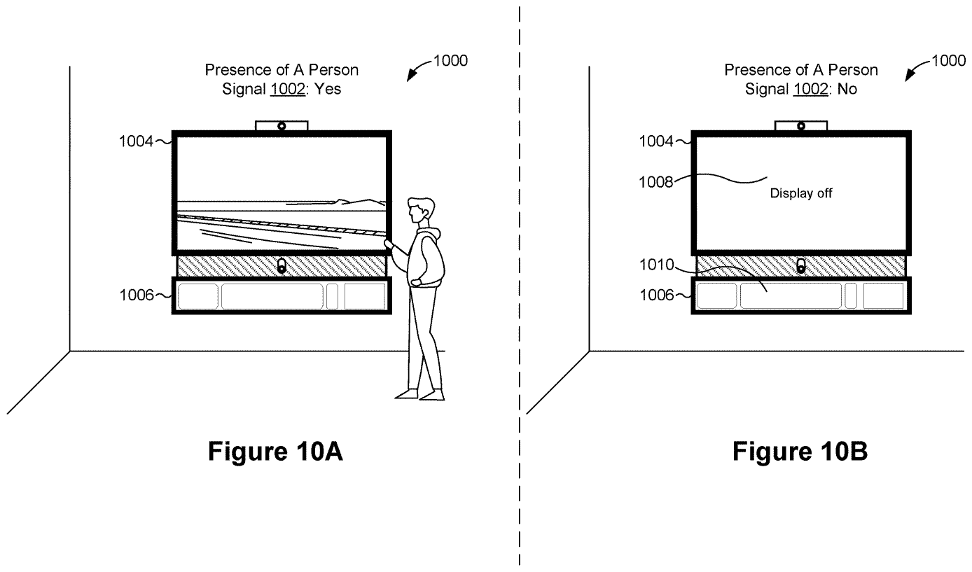

FIGS. 10A-10B illustrate how a display system 1000 responds to detecting that a presence of a person signal 1002 is no longer within a region of the display system 1000, in accordance with some embodiments. As shown in FIG. 10A, a presence of a person signal 1002 is within a predefined region (e.g., 10, 20, 30 feet of the display system) of the display system 1000. As a result the display system 1000 keeps a first display 1004 and a second display 1006 in an activated-on state as a presence of a person signal 1002 is within proximity of the display system 1000.

FIG. 10B illustrates that in response to a presence of a person signal 1002 no longer being in proximity (e.g., outside of a predefined distance and for a predefined period of time (e.g. 5, 10, 20 minutes)) to the display system 1000, the first display 1004 of the display system 1000 enters a deactivated-off state 1008 (e.g., a display off state) and maintains an activated-on state 1010 (e.g., un-dimmed) state for the second display 1006.

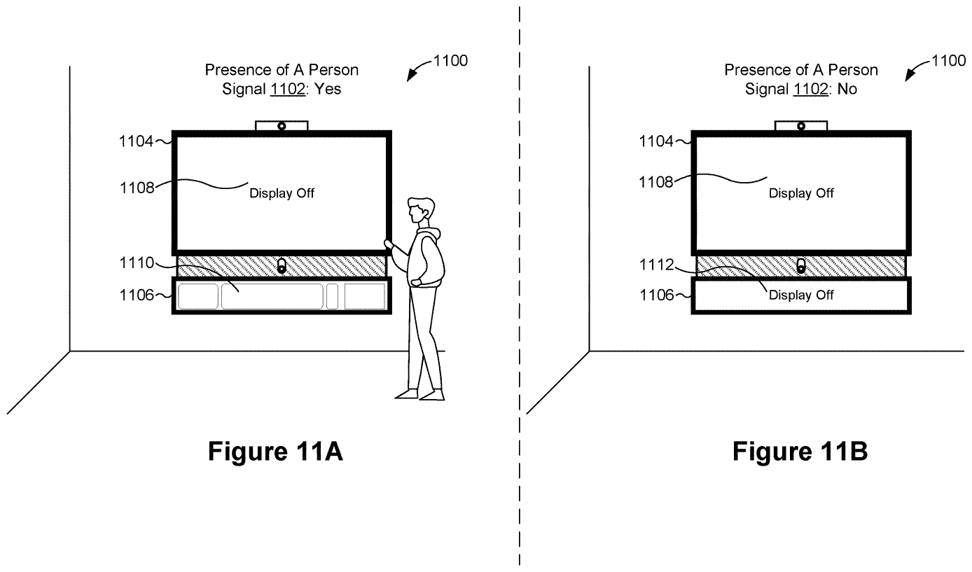

FIGS. 11A-11B illustrate how a display system 1100 responds to detecting that a presence of a person signal 1102 is no longer within a region of the display system 1100, in accordance with some embodiments. As shown in FIG. 11A, the presence of a person signal 1102 is within a predefined region (e.g., 10, 20, 30 feet of the display system) of the display system 1100. As a result the display system 1100 keeps a second display 1106 in an activated-on state 1110 as a presence of a person signal 1102 is within proximity of the display system 1100 and a first display 1104 is in a deactivated-off state 1108.

FIG. 11B illustrates that in response to a presence of a person signal 1102 no longer being in proximity (e.g., outside of a predefined distance and for a predefined period of time (e.g. 5, 10, 20 minutes)) to the display system 1100, the first display 1104 stays in a deactivated off state 1108 and the second display 1106 of the display system 1100 enters a deactivated-off state 1112 (e.g., a display off state or standby state).

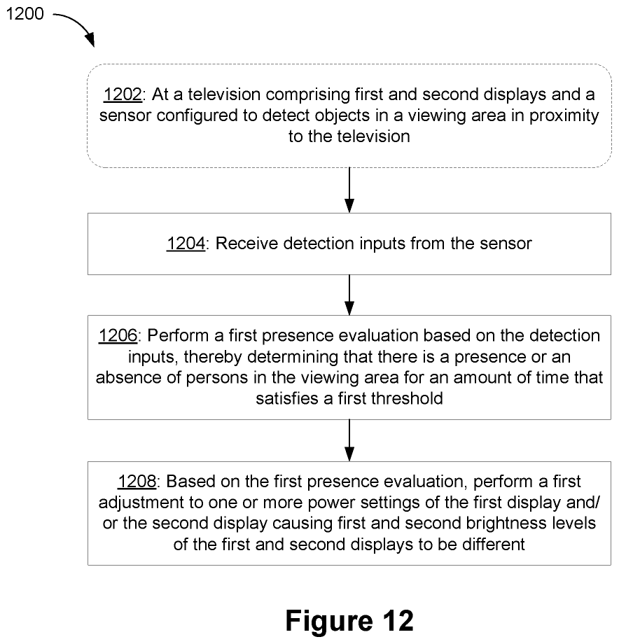

FIG. 12 includes a method flow chart 1200 that describes additional embodiments and variations of the embodiments described in reference to FIGS. 1-11B, in accordance with some embodiments.

(A1) In accordance with some embodiments, a television, that provides a person detection, comprises a first display configured to display streaming video content at a first brightness level (e.g., upper screen 110 described in relation to FIG. 1 and a first display 600, 700; 800, 904, 904, 904 described in relation to FIGS. 6A-6B, 7A-7B, 8A-8B, 9A-9B, 10A-10B, and 11A-11B, respectively) (1202). The television comprises a second display configured to display interactive content supplemental to the video content at a second brightness level, and the second display is physically separated from the first display (e.g., separated by a sound bar or other intermediary component). For example, a lower screen 130 is described in reference to FIG. 1 and a secondary display 602, 702, 802, 906, 1006, and 1106 described in relation to FIGS. 6A-6B, 7A-7B, 8A-8B, 9A-9B, 10A-10B, and 11A-11B, respectively (1202). The television comprises a sensor configured to detect objects in a viewing area in proximity to the television (e.g., a presence sensor 150 described in relation to FIG. 1). The television also comprises one or more processors and memory storing one or more programs for execution by the one or more processors, the one or more programs including instructions that cause the one or more processors to receive (1204) detection inputs from the sensor (e.g., FIGS. 6A-11B illustrate the sensor determining the presence and movement of a person in an environment surrounding the television). The one or more programs further include instructions that cause the one or more processors to perform (1304) a first presence evaluation based on the detection inputs. In some embodiments, the first presence evaluation determines that there is a presence or an absence of persons in the viewing area for an amount of time that satisfies a first threshold (e.g., FIGS. 6A-11B illustrate sensor data being used to determine the presence or absence of a person or persons in a viewing area of the television). The one or more programs further include instructions that cause the one or more processors to, based on the first presence evaluation, perform (1208) a first adjustment to one or more power settings of the first display and/or the second display causing the first brightness level and the second brightness level to be different (e.g., FIGS. 6A-11B illustrate the first display and second display adjusting their brightness levels and/or turning on and off based on the determined presence or absence of a person within proximity of the television).

(A2) In some embodiments of A1, the first presence evaluation determines that there is an absence of persons in the viewing area for an amount of time that satisfies the first threshold; and performing the first adjustment causes the first brightness level to be lower than the second brightness level. For example, FIGS. 9A-9B show that in response to a presence of a person signal 902 no longer being detected for a predefined amount of time (e.g., 5 minutes) the first display 904 enters a dimmed state 908.

(A3) In some embodiments of A2 a second presence evaluation determines that there is an absence of persons in the viewing area for an amount of time that satisfies a second threshold; and based on the second presence evaluation, the one or more processors perform a second adjustment to the one or more power settings causing the first display to enter a standby mode and the second display to maintain a brightness level less than or equal to the second brightness level. For example, FIG. 10A-10B illustrate another interaction where after a different time period the first display enters an off state 1004, and optionally the second display 1006 enters a dimmed state.

(A4) In some embodiments of A3, a third presence evaluation determines that there is an absence of persons in the viewing area for an amount of time that satisfies a third threshold; and based on the third presence evaluation, the one or more processors perform a third adjustment to the one or more power settings causing the first display to remain in the standby mode and the second display to enter the standby mode. For example FIG. 11A-11B shows that in response to a an amount of time that satisfies a third threshold, the first display 1104 maintains a standby mode (e.g., a deactivated-off state 1108) and the second display 1106 enters a standby mode (e.g., a deactivated-off state 1112).

(A5) In some embodiments of A4, the first presence evaluation determines that there is a presence of one or more persons in the viewing area for an amount of time that satisfies the first threshold; and performing the first adjustment causes the second brightness level to be higher than the first brightness level. For example, FIGS. 6A-6B, 7A-7B, 8A-8B each show that in response to a presence of a person being detected either the first display and/or the second display either exits a standby state and/or enters a non-dimmed state.

(A6) In some embodiments of A5, a second presence evaluation determines that there is a presence of one or more persons in the viewing area for an amount of time that satisfies a second threshold, and based on the second presence evaluation, the one or more processors perform a second adjustment to the one or more power settings causing the second brightness level to be substantially equal to the first brightness level. For example, FIGS. 6A-6B, 7A-7B, 8A-8B each show that in response to a presence of a person being detected either the first display and/or the second display either exits a standby state and/or enters a non-dimmed state.

(A7) In some embodiments according to any one of A1-A6, the standby mode causes the first display and/or the second display to be powered off. For example, FIGS. 10A-10B and 11A-11B each show at least one of the displays entering a powered off mode in response to detecting a person no longer being in proximity to the television.

(A8) In some embodiments according to any one of A1-A8, the sensor is a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor. For example, the sensor 150 described in reference to FIG. 1 is described as being a radar sensor in some embodiments.

(A9) In some embodiments according to any one of claims 1-8, the first presence evaluation further determines a number of persons in the viewing area, a distance from the television to one or more persons in the viewing area, and/or a movement of one or more persons in the viewing area; and the one or more processors perform the first adjustment based on the number of persons, the distance, and/or a movement.

(B1) In accordance with some embodiments, a non-transitory computer readable storage medium storing one or more programs configured for execution by one or more processors, the one or more programs including instructions that cause the one or more processors to, receive detection inputs from a sensor configured to detect objects in a viewing area in proximity to a television coupled to the sensor, the television comprising a first display configured to display streaming video content at a first brightness level and a second display configured to display interactive content supplemental to the video content at a second brightness level. For example, FIG. 1 shows that the upper screen 110 can be configured to display primary content (e.g., cable tv, streaming services, or other traditionally viewed media that is displayed on televisions), and the lower screen 130 can display widget programs 140 (e.g., picture-in-picture displays, application information for apps installed on a smart tv (e.g., stock info, weather info, etc.), advertisements, etc. ,). The one or more programs including instructions that cause the one or more processors to perform a first presence evaluation based on the detection inputs, wherein the first presence evaluation determines that there is a presence or an absence of persons in the viewing area for an amount of time that satisfies a first threshold; and based on the first presence evaluation, perform a first adjustment to one or more power settings of the first display and/or the second display causing the first brightness level and the second brightness level to be different.

(B2) In some embodiments of B1, the first presence evaluation determines that there is an absence of persons in the viewing area for an amount of time that satisfies the first threshold; and performing the first adjustment causes the first brightness level to be lower than the second brightness level. For example, FIGS. 10A-10B show that in response to a a presence of a person signal 1002 no longer being detected for a predefined amount of time (e.g., 5 minutes) the first display 1004 enters a dimmed state 1008.

(B3) In some embodiments of B2, a second presence evaluation determines that there is an absence of persons in the viewing area for an amount of time that satisfies a second threshold; and based on the second presence evaluation, the one or more processors perform a second adjustment to the one or more power settings causing the first display to enter a standby mode and the second display to maintain a brightness level less than or equal to the second brightness level. For example, FIG. 10A-10B illustrate another interaction where after a different time period the first display enters an off state 1004, and optionally the second display 1006 enters a dimmed state.

(B4) In some embodiments of B3, a third presence evaluation determines that there is an absence of persons in the viewing area for an amount of time that satisfies a third threshold; and based on the third presence evaluation, the one or more processors perform a third adjustment to the one or more power settings causing the first display to remain in the standby mode and the second display to enter the standby mode. For example FIG. 12A-12B shows that in response to a an amount of time that satisfies a third threshold, the first display 1204 maintains a standby mode (e.g., a deactivated-off state 1208) and the second display 1206 enters a standby mode (e.g., a deactivated-off state 1212).

(B5) In some embodiments of B1, the first presence evaluation determines that there is a presence of one or more persons in the viewing area for an amount of time that satisfies the first threshold; and performing the first adjustment causes the second brightness level to be higher than the first brightness level. For example, FIGS. 6A-6B, 7A-7B, and 8A-8B each show that in response to a presence of a person being detected either the first display and/or the second display either exits a standby state and/or enters a non-dimmed state.

(B6) In some embodiments of B5, a second presence evaluation determines that there is a presence of one or more persons in the viewing area for an amount of time that satisfies a second threshold; and based on the second presence evaluation, the one or more processors perform a second adjustment to the one or more power settings causing the second brightness level to be substantially equal to the first brightness level. For example, FIGS. 6A-6B, 7A-7B, and 8A-8B each show that in response to a presence of a person being detected either the first display and/or the second display either exits a standby state and/or enters a non-dimmed state.

(B7) In some embodiments according to any one of claims B1-B6, the standby mode causes the first display and/or the second display to be powered off. For example, FIGS. 10A-10B and 11A-11B each show at least one of the displays entering a powered off mode in response to detecting a presence of a person no longer being in proximity to the television.

(B8) In some embodiments according to any one of claims B1-B7, the sensor is a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor. For example, the sensor 150 described in reference to FIG. 1 is described as being a radar sensor in some embodiments.

(B9) In some embodiments according to any one of claims B1-B8, the first presence evaluation further determines a number of persons in the viewing area, a distance from the television to one or more persons in the viewing area, and/or the movement of one or more persons in the viewing area; and the one or more processors perform the first adjustment based on the number of persons, the distance, and/or the movement.

Reference have been made in detail to various implementations, examples of which are illustrated in the accompanying drawings. In the above detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

It will be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, without changing the meaning of the description, so long as all occurrences of the first device are renamed consistently and all occurrences of the second device are renamed consistently. The first device and the second device are both devices, but they are not the same device.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, “A, B, and/or C” means: A only; B only; C only; A and B; A and C; B and C; or A, B, and C. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. The television that provides a person detection, comprising:
a first display configured to display streaming video content at a first brightness level;
a second display configured to display interactive content supplemental to the video content at a second brightness level, wherein the second display is physically separated from the first display;
a sensor configured to detect objects in a viewing area in proximity to the television;
one or more processors and memory storing one or more programs for execution by the one or more processors, the one or more programs including instructions that cause the one or more processors to:
receive detection inputs from the sensor;
perform a first presence evaluation based on the detection inputs, wherein the first presence evaluation determines that there is a presence or an absence of persons in the viewing area for an amount of time that satisfies a first threshold; and
based on the first presence evaluation, perform a first adjustment to one or more power settings of the first display and/or the second display causing the first brightness level and the second brightness level to be different.

2. The television of claim 1, wherein:
the first presence evaluation determines that there is an absence of persons in the viewing area for an amount of time that satisfies the first threshold; and
performing the first adjustment causes the first brightness level to be lower than the second brightness level.

3. The television of claim 2, wherein:
a second presence evaluation determines that there is an absence of persons in the viewing area for an amount of time that satisfies a second threshold; and
based on the second presence evaluation, the one or more processors perform a second adjustment to the one or more power settings causing the first display to enter a standby mode and the second display to maintain a brightness level less than or equal to the second brightness level.

4. The television of claim 3, wherein:
a third presence evaluation determines that there is an absence of persons in the viewing area for an amount of time that satisfies a third threshold; and
based on the third presence evaluation, the one or more processors perform a third adjustment to the one or more power settings causing the first display to remain in the standby mode and the second display to enter the standby mode.

5. The television of claim 1, wherein:
the first presence evaluation determines that there is a presence of one or more persons in the viewing area for an amount of time that satisfies the first threshold; and
performing the first adjustment causes the second brightness level to be higher than the first brightness level.

6. The television of claim 5, wherein:
a second presence evaluation determines that there is a presence of one or more persons in the viewing area for an amount of time that satisfies a second threshold; and
based on the second presence evaluation, the one or more processors perform a second adjustment to the one or more power settings causing the second brightness level to be substantially equal to the first brightness level.

7. The television according to any one of claims 1-6, wherein the standby mode causes the first display and/or the second display to be powered off.

8. The television according to any one of claims 1-7, wherein the sensor is a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor.

9. The television according to any one of claims 1-8, wherein:
the first presence evaluation further determines a number of persons in the viewing area, a distance from the television to one or more persons in the viewing area, and/or the movement of one or more persons in the viewing area; and
the one or more processors perform the first adjustment based on the number of persons, the distance, and/or the movement.

10. A non-transitory computer readable storage medium storing one or more programs configured for execution by one or more processors, the one or more programs including instructions that cause the one or more processors to:
receive detection inputs from a sensor configured to detect objects in a viewing area in proximity to a television coupled to the sensor, the television comprising a first display configured to display streaming video content at a first brightness level and a second display configured to display interactive content supplemental to the video content at a second brightness level;
perform a first presence evaluation based on the detection inputs, wherein the first presence evaluation determines that there is a presence or an absence of persons in the viewing area for an amount of time that satisfies a first threshold; and
based on the first presence evaluation, perform a first adjustment to one or more power settings of the first display and/or the second display causing the first brightness level and the second brightness level to be different.

11. The non-transitory computer readable storage medium of claim 10, wherein:
the first presence evaluation determines that there is an absence of persons in the viewing area for an amount of time that satisfies the first threshold; and
performing the first adjustment causes the first brightness level to be lower than the second brightness level.

12. The non-transitory computer readable storage medium of claim 11, wherein:
a second presence evaluation determines that there is an absence of persons in the viewing area for an amount of time that satisfies a second threshold; and
based on the second presence evaluation, the one or more processors perform a second adjustment to the one or more power settings causing the first display to enter a standby mode and the second display to maintain a brightness level less than or equal to the second brightness level.

13. The non-transitory computer readable storage medium of claim 12, wherein:
a third presence evaluation determines that there is an absence of persons in the viewing area for an amount of time that satisfies a third threshold; and
based on the third presence evaluation, the one or more processors perform a third adjustment to the one or more power settings causing the first display to remain in the standby mode and the second display to enter the standby mode.

14. The non-transitory computer readable storage medium of claim 10, wherein:
the first presence evaluation determines that there is a presence of one or more persons in the viewing area for an amount of time that satisfies the first threshold; and
performing the first adjustment causes the second brightness level to be higher than the first brightness level.

15. The non-transitory computer readable storage medium of claim 11, wherein:
a second presence evaluation determines that there is a presence of one or more persons in the viewing area for an amount of time that satisfies a second threshold; and
based on the second presence evaluation, the one or more processors perform a second adjustment to the one or more power settings causing the second brightness level to be substantially equal to the first brightness level.

16. The non-transitory computer readable storage medium according to any one of claims 10-15, wherein the standby mode causes the first display and/or the second display to be powered off.

17. The non-transitory computer readable storage medium according to any one of claims 10-16, wherein the sensor is a time-of-flight (ToF) sensor, an infrared (IR) sensor, a thermal sensor, a millimeter wave sensor, an ultrawideband (UWB) sensor, an ultrasonic sensor, a WiFi sensor, a Bluetooth Low Energy (BLE) sensor, or a radar-based sensor.

18. The non-transitory computer readable storage medium according to any one of claims 10-17, wherein:
the first presence evaluation further determines a number of persons in the viewing area, a distance from the television to one or more persons in the viewing area, and/or a movement of one or more persons in the viewing area; and
the one or more processors perform the first adjustment based on the number of persons, the distance, and/or a movement.
